(19) United States
(12) Patent Application Publication
(10) Pub. No.: US 2021/0124206 A1
(43) Pub. Date: Apr. 29, 2021

(54) TFT ARRAY SUBSTRATE AND LCD PANEL

(71) Applicant: Wuhan China Star Optoelectronics Technology Co., Ltd., Wuhan (CN)

(72) Inventors: Yafeng Li, Wuhan (CN); Jinfang Wu, Wuhan (CN)

(21) Appl. No.: 16/308,483

(22) PCT Filed: Sep. 27, 2018
(86) PCT No.: PCT/CN2018/108019

§ 371 Date: Dec. 10, 2018

(30) Foreign Application Priority Data
May 29, 2018 (CN) 201810532886.2

(51) Int. Cl. G02F 1/1362; G02F 1/1333; G02F 1/1343; G06F 3/041

(52) U.S. Cl. CPC G02F 1/13629; G02F 1/13338; G02F 1/134318; G02F 1/13685; G02F 1/134363; G02F 1/136209; G06F 3/0412

(57) ABSTRACT

The invention provides a TFT array substrate and LCD panel. the TFT array substrate comprises a first metal layer, a first interlayer insulating layer, a second metal layer, a second interlayer insulating layer and a third metal layer sequentially disposed above the substrate. The first, second and third metal layers comprise a plurality of first, second and third fanout lines in the fanout line area, respectively; two of the first, second, and third fanout lines are connected to the data lines, and the other is connected with the touch line; because the first interlayer insulating layer is disposed between the first and second fanout lines, and the second interlayer insulating layer is disposed between the third and second fanout lines, the first, second and third fanout lines can overlap, which can effectively reduce the fanout line area and help to achieve a narrow border.

### BACKGROUND OF THE INVENTION

### 1. Field of the Invention

The present invention relates to the field of display, and in particular to a thin film transistor (TFT) array substrate and liquid crystal display (LCD) panel.

### 2. The Related Arts

In the field of display technology, a panel display device, such as liquid crystal display (LCD), organic light-emitting diode (OLED) display device, has gradually replaced a cathode ray tube (CRT) display device. The LCD has many advantages such as thinness, power saving, no radiation, and so on, and has been widely used.

Most of the LCD devices on the market are backlight type LCD devices, which comprise an LCD panel and a backlight module. Generally, an LCD panel comprises a color filter (CF) substrate, a thin film transistor (TFT) array substrate, and a liquid crystal (LC) sandwiched between the CF substrate and the TFT array substrate, and a sealant. The operation principle of the LCD panel is to place LC molecules in two parallel glass substrates. There are many vertical and horizontal thin wires between the two glass substrates, and the LC molecules are controlled to change direction by energizing the wires or not to refract the light of the backlight module to produce an image.

Referring to FIG. 1, FIG. 1 is a schematic cross-sectional view showing the structure of a known TFT array substrate. The TFT array substrate comprises a substrate 31, a light-shielding layer 32 disposed on the substrate 31, an underlying insulating layer 33 covering the light-shielding layer 32, an active layer 34 disposed on the underlying insulating layer 33, a gate insulating layer 35 covering the active layer 34, a first metal layer disposed on the gate insulating layer 35, an interlayer insulating layer 37 covering the first metal layer, a second metal layer disposed on the interlayer insulating layer 37, and a planarization layer 39 covering the second metal layer, a third metal layer disposed on the planarization layer 39, a top insulating layer 311 covering the third metal layer, a common electrode 312 disposed on the top insulating layer 311, and a passivation layer 313 disposed on the common electrode 312, and a pixel electrode 314 disposed on the passivation layer 313; wherein the first metal layer comprises a gate 36 above the active layer 34, the second metal layer comprises a source and a drain 38 and a plurality of data lines used for transmitting data signal, the third metal layer comprises a touch wire 310 used for transmitting a touch signal. The common electrode 312 is connected to the touch wire 310 through a via on the top insulating layer 311. Refer to FIG. 2. The fanout area of the TFT array substrate shown in FIG. 1 comprises a plurality of first fanout lines 301, second fanout lines 302 and third fanout lines 303. The plurality of first fanout lines 301 are all located in the first metal layer, and the plurality of second fanout lines 302 are all located in the second metal layer. The plurality of first fanout line 301 and the plurality of second fanout lines 302 are respectively electrically connected to the plurality of data lines. The plurality of third fanout lines 303 are respectively located in the third metal layer, and the plurality of third fanout lines 303 are respectively electrically connected to the plurality of touch wires 310. Because the first metal layer, the second metal layer, and the third metal layer mutually insulated from one another, the first fanout lines 301, the second fanout lines 302, and the third fanout lines 303 can overlap one another, which can reduce the size of the fanout area to a certain extent to achieve a narrow border. However, the TFT array substrate needs to use 12 masks during fabrication, which is complicated and costly.

To reduce the number of masks and the complexity of the process to reduce the product cost, as shown in FIG. 3, the prior art proposes another TFT array substrate comprising a substrate 81 and a light-shielding layer 82 disposed on the substrate 81, an underlying insulating layer 83 covering the light-shielding layer 82, an active layer 84 disposed on the underlying insulating layer 83, a gate insulating layer 85 covering the active layer 84, a first metal layer disposed on the gate insulating layer 85, an interlayer insulating layer 87 covering the first metal layer, a second metal layer disposed on the interlayer insulating layer 87, and a planarization layer 89 covering the second metal layer, a common electrode 810 disposed on the planarization layer 89, a passivation layer 811 on the common electrode 810 and a pixel electrode 812 disposed on the passivation layer 811; wherein the first metal layer comprises a gate 86 above the active layer 84, and the second metal layer comprises a source and drain electrode 881, a plurality of data lines and a plurality of touch wires 882, the data lines are used for transmitting data signals, the touch wires 882 are used for transmitting touch signals, and the common electrodes 810 is connected to the touch line 882 through the vias on the planarization layer 89. The number of masks required to fabricate the TFT array substrate shown in FIG. 3 is 10, which can reduce the number of masks. However, referring to FIG. 4, the fanout area of the TFT array substrate shown in FIG. 3 comprises a plurality of first fanout lines 801 and the second fanout lines 802. The first fanout lines 801 are located on the first metal layer, and the second fanout lines 802 are located on the second metal layer. The plurality of first fanout lines 801 are respectively electrically connected to the plurality of data lines and the plurality of second fanout lines 802 are respectively electrically connected to the plurality of touch lines 872. Or, the plurality of second fanout lines 802 are respectively electrically connected to the plurality of data lines and the plurality of first fanout lines 801 are respectively electrically connected to the plurality of touch lines 882. In either case, the fanout lines connecting the plurality of data lines are all located on the same metal layer, and cannot overlap each other, so that the size of the fanout area cannot be compressed, and the greater the density of the pixels (pixel per inch, PPI) is, the more prominent the problem of not being able to compress the size of the fanout lines area, which restricts the development of the display panel toward the narrow border.

### SUMMARY OF THE INVENTION

The object of the present invention is to provide a TFT array substrate, having small-size fanout line area and beneficial to realize narrow border.

Another object of the present invention is to provide an LCD, having small-size fanout line area and beneficial to realize narrow border.

To achieve the above object, the present invention provides a TFT array substrate, which comprises: a substrate, a first metal layer disposed over the substrate, a first interlayer insulating layer covering the first metal layer, a second metal layer disposed on the first interlayer insulating layer, a second interlayer insulating layer covering the second metal layer, and a third metal layer disposed on the second interlayer insulating layer;

the substrate comprising an effective active area and a fanout line area disposed in sequence; the first metal layer comprising a plurality of first fanout lines located in the fanout line area; and the second metal layer comprising a plurality of touch lines located in the effective active area and a plurality of second fanout lines located in the fanout line area; the third metal layer comprising a plurality of data lines located in the effective active area and a plurality of third fanout lines located in the fanout line area;

the plurality of first fanout lines and the plurality of second fanout lines being respectively electrically connected to the plurality of data lines, and the plurality of third fanout lines being respectively electrically connected to the plurality of touch lines; or

the plurality of first fanout lines and the plurality of third fanout lines being respectively electrically connected to the plurality of data lines, and the plurality of second fanout lines being respectively electrically connected to the plurality of touch lines; or

the plurality of second fanout lines and the plurality of third fanout lines being electrically connected to the plurality of data lines, and the plurality of first fanout lines being electrically connected to the plurality of touch lines.

The plurality of first fanout lines and the plurality of second fanout lines are respectively electrically connected to the plurality of data lines, and the plurality of third fanout lines are respectively electrically connected to the plurality of touch lines;

each of the first fanout lines corresponds to a data line, and the first interlayer insulating layer and the second interlayer insulating layer are disposed with a plurality of first vias located above the plurality of first fanout lines, and the first fanout line is connected to the corresponding data line through the first via;

each of the second fanout lines corresponds to a data line, and the second interlayer insulating layer is disposed with a plurality of second vias located above the plurality of second fanout lines, and the second fanout line is connected to the corresponding data line through the second via;

each of the third fanout lines corresponds to a touch line, and the second interlayer insulating layer is provided with a plurality of third vias located above the plurality of touch lines, and the third fanout line is connected to the corresponding touch line through the third via.

The plurality of first fanout lines and the plurality of second fanout lines are used for receiving data signals, and the plurality of third fanout lines are used for receiving touch signals.

The plurality of first fanout lines and the plurality of third fanout lines are respectively electrically connected to the plurality of data lines, and the plurality of second fanout lines are respectively electrically connected to the plurality of touch lines;

each of the first fanout lines corresponds to a data line, and the first interlayer insulating layer and the second interlayer insulating layer are disposed with a plurality of first vias located above the plurality of first fanout lines, and the first fanout line is connected to the corresponding data line through the first via;

each of the third fanout lines is connected to a data line correspondingly;

each of the second fanout lines is connected to a touch line correspondingly.

The plurality of first fanout lines and the plurality of third fanout lines are used for receiving data signals, and the plurality of second fanout lines are used for receiving touch signals.

The plurality of second fanout lines and the plurality of third fanout lines are electrically connected to the plurality of data lines, and the plurality of first fanout lines are electrically connected to the plurality of touch lines;

each of the second fanout lines corresponds to a data line, and the second interlayer insulating layer is disposed with a plurality of second vias located above the plurality of second fanout lines, and the second fanout line is connected to the corresponding data line through the second via;

each of the third fanout lines is connected to a data line correspondingly;

each of the first fanout lines corresponds to a touch line, and the second interlayer insulating layer is disposed with a plurality of fourth vias above the plurality of touch lines, the first interlayer insulating layer and the second interlayer insulating layer are disposed with a plurality of fifth vias located above the plurality of first fanout lines; the third metal layer further comprises a plurality of connection lines respectively corresponding to the plurality of touch line; the connection line connects the corresponding touch line to the first fanout line through the fourth via and the fifth via.

The plurality of second fanout lines and the plurality of third fanout lines are used for receiving data signals, and the plurality of first fanout lines are used for receiving touch signals.

The TFT array substrate further comprises an active layer over the substrate and a gate insulating layer covering the active layer; the first metal layer is disposed on the gate insulating layer;

the TFT array substrate further comprises a planarization layer covering the third metal layer, a common electrode layer disposed on the planarization layer, a passivation layer covering the common electrode layer, and a pixel electrode layer disposed on the passivation layer;

the active layer comprises a plurality of semiconductor patterns located in an effective active area;

the first metal layer further comprises a plurality of gates located in the effective active area and correspondingly located above the plurality of semiconductor patterns;

the third metal layer further comprises a plurality of sources and a plurality of drains respectively located in the effective active area and corresponding to the plurality of gates, and a plurality of connection electrodes located in the effective active area;

the gate insulating layer, the first interlayer insulating layer and the second interlayer insulating layer are disposed with a plurality of sixth vias located at two ends of the plurality of semiconductor patterns; the source and the drain corresponding to a semiconductor pattern respectively is connected to both ends of the semiconductor pattern through a sixth via above the two ends of the semiconductor pattern;

the second interlayer insulating layer is disposed with a plurality of seventh vias located above the plurality of touch lines, and each of the connection electrodes is connected to a touch line via the seventh via;

the planarization layer is disposed with a plurality of eighth vias located above the plurality of connection electrodes; the common electrode layer comprises a plurality of common electrodes spaced apart, and each common electrode is connected to a connection electrode through the eighth via;

the planarization layer and the passivation layer are disposed with a plurality of ninth vias located above the plurality of drains; the pixel electrode layer comprises a plurality of pixel electrodes spaced apart, and each of the pixel electrodes is connected to a drain through the ninth via;

the first interlayer insulating layer is made of silicon nitride;

the second interlayer insulating layer is made of silicon oxide;

the gate insulating layer is made of silicon oxide;

the common electrode layer is made of indium tin oxide (ITO);

the element electrode layer is made of ITO;

the second metal layer is made of titanium or molybdenum.

The TFT array substrate further comprises a light-shielding layer disposed on the substrate and an underlying insulating layer covering the light-shielding layer; the active layer is disposed on the underlying insulating layer.

The present invention also provides a liquid crystal display panel comprising the above TFT array substrate.

The present invention provides the following advantages: the TFT array substrate provided by the present invention comprises a first metal layer, a first interlayer insulating layer, a second metal layer, a second interlayer insulating layer and a third metal layer which are sequentially disposed above the substrate, and the first metal layer comprises a plurality of first fanout lines in the fanout line area, the second metal layer comprises a plurality of second fanout lines located in the fanout line area, and the third metal layer comprises a plurality of third lines located in the fanout line area; two of the first fanout line, the second fanout line, and the third fanout line are connected to the data lines, and the other is connected with the touch line; because the first interlayer insulating layer is disposed between the first fanout line and the second fanout line, and the second interlayer insulating layer is disposed between the third fanout line and the second fanout line, the first fanout line, the second fanout line, and the third fanout line can overlap, which can effectively reduce the fanout line area and help to achieve a narrow border. The fanout line area of an LCD panel provided by the invention has a small size, which is advantageous for realizing a narrow border.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a partial cross-sectional view showing a known TFT array substrate;

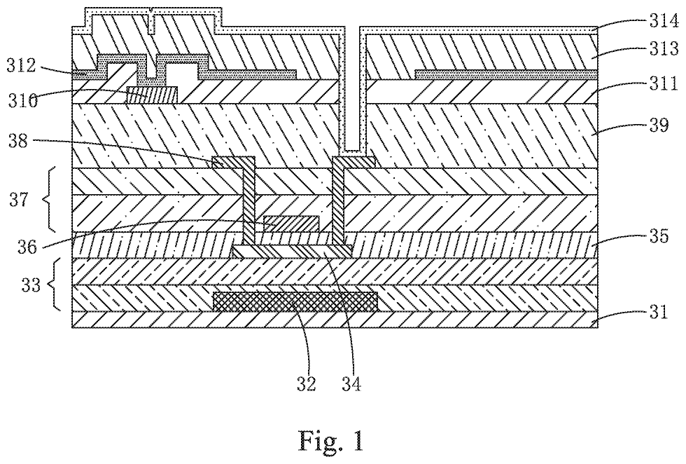

FIG. 2 is a schematic top view showing the first fanout line, second fanout line, and third fanout line of the TFT array substrate in FIG. 1;

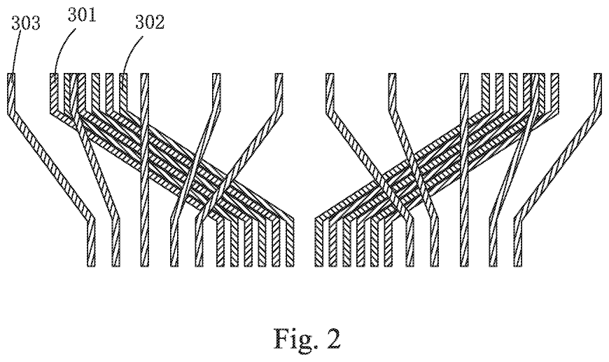

FIG. 3 is a partial cross-sectional view showing another known TFT array substrate;

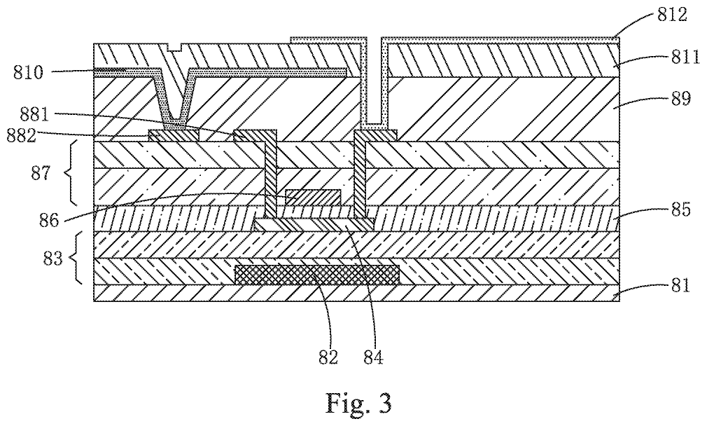

FIG. 4 is a schematic top view showing the first fanout line and second fanout line of the TFT array substrate in FIG. 2;

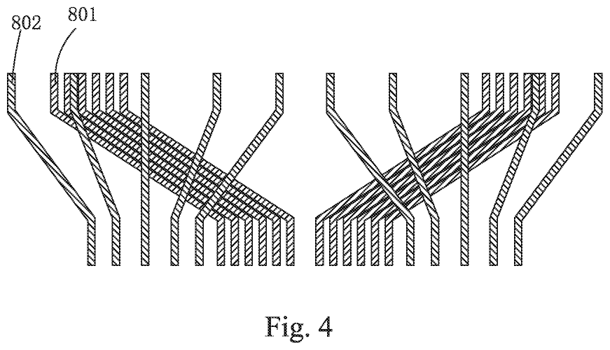

FIG. 5 is a schematic top view showing the substrate, first metal layer, second metal layer and third metal layer of the TFT array substrate of the first embodiment of the present invention;

FIG. 6 is a partial cross-sectional view showing the effective active area of the TFT array substrate of the present invention;

FIG. 7 is a schematic cross-sectional view showing the connection of the first fanout line and corresponding data line of the TFT array substrate of the first embodiment and second embodiment of the present invention;

FIG. 8 is a schematic cross-sectional view showing the connection of the second fanout line and corresponding data line of the TFT array substrate of the first embodiment and third embodiment of the present invention;

FIG. 9 is a schematic cross-sectional view showing the connection of the third fanout line and corresponding data line of the TFT array substrate of the first embodiment of the present invention;

FIG. 10 is a schematic top view showing the substrate, first metal layer, second metal layer and third metal layer of the TFT array substrate of the second embodiment of the present invention;

FIG. 11 is a schematic top view showing the substrate, first metal layer, second metal layer and third metal layer of the TFT array substrate of the third embodiment of the present invention;

FIG. 12 is a schematic cross-sectional view showing the connection of the first fanout line and corresponding touch line of the TFT array substrate of the third embodiment of the present invention.

### DETAILED DESCRIPTION OF THE PREFERRED EMBODIMENTS

To further explain the technical means and effect of the present invention, the following refers to embodiments and drawings for detailed description.

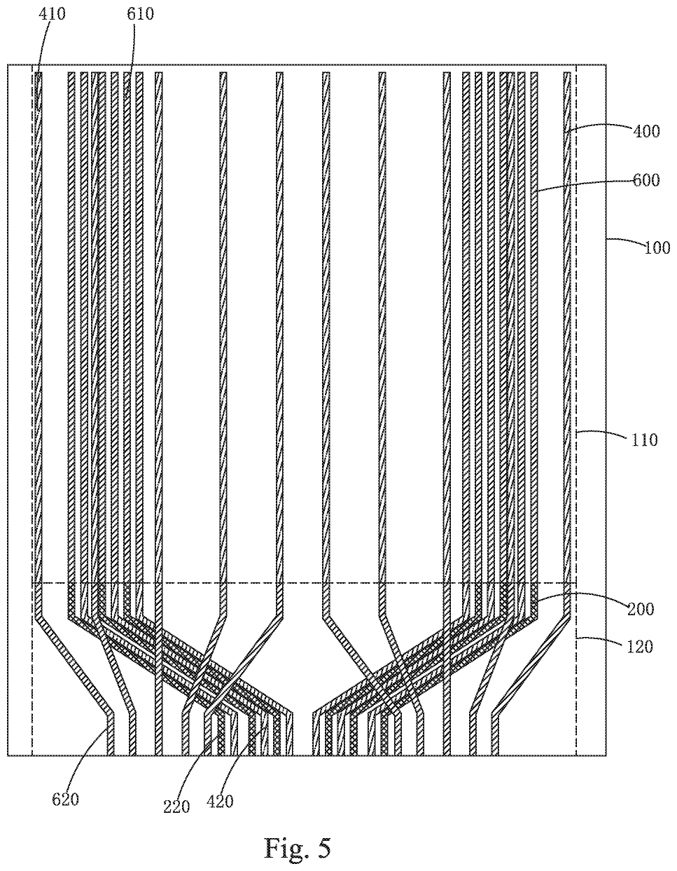

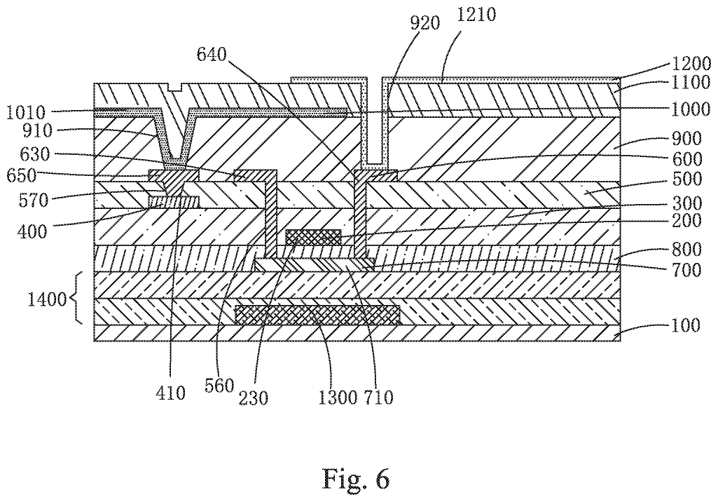

Refer to FIG. 5 and FIG. 6. The TFT array substrate of the first embodiment of the present invention comprises: a substrate 100, a first metal layer 200 disposed over the substrate 100, a first interlayer insulating layer 300 covering the first metal layer 200, a second metal layer 400 disposed on the first interlayer insulating layer 300, a second interlayer insulating layer 500 covering the second metal layer 400, and a third metal layer 600 disposed on the second interlayer insulating layer 500.

The substrate 100 comprises an effective active area 110 and a fanout line area 120 disposed in sequence. The first metal layer 200 comprises a plurality of first fanout lines 220 located in the fanout line area 120; and the second metal layer 400 comprises a plurality of touch lines 410 located in the effective active area 110 and a plurality of second fanout lines 420 located in the fanout line area 120; the third metal layer 600 comprises a plurality of data lines 610 located in the effective active area 110 and a plurality of third fanout lines 620 located in the fanout line area 120.

It should be noted that the plurality of first fanout lines 220 and the plurality of second fanout lines 420 are respectively electrically connected to the plurality of data lines 610, and the plurality of third fanout lines 620 are respectively electrically connected to the plurality of touch lines 410.

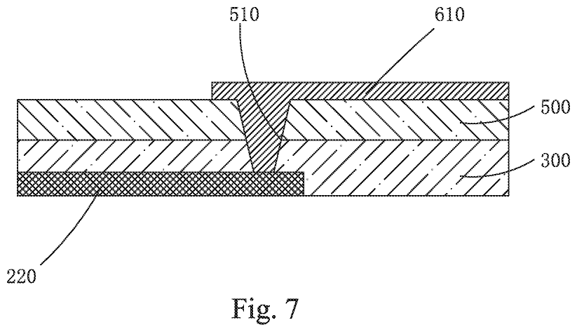

Specifically, refer to FIG. 6 and FIG. 7. Each of the first fanout lines 220 corresponds to a data line 610, and the first interlayer insulating layer 300 and the second interlayer insulating layer 500 are disposed with a plurality of first vias 510 located above the plurality of first fanout lines 220, and the first fanout line 220 is connected to the corresponding data line 610 through the first via 510.

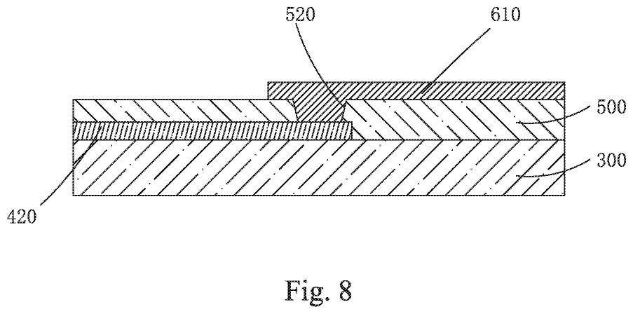

Refer to FIG. 6 and FIG. 8. Each of the second fanout lines 420 corresponds to a data line 610, and the second interlayer insulating layer 500 is disposed with a plurality of second vias 520 located above the plurality of second fanout lines 420, and the second fanout line 420 is connected to the corresponding data line 610 through the second via 520.

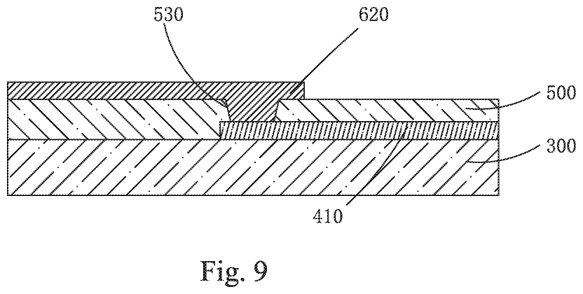

Refer to FIG. 6 and FIG. 9. Each of the third fanout lines 620 corresponds to a touch line 410, and the second interlayer insulating layer 500 is provided with a plurality of third vias 530 located above the plurality of touch lines 410, and the third fanout line 620 is connected to the corresponding touch line 410 through the third via 530.

Moreover, in the first embodiment of the present invention, the plurality of first fanout lines 220 and the plurality of second fanout lines 420 are used for receiving data signals, and the plurality of third fanout lines 620 are used for receiving touch signals.

Specifically, referring to FIG. 6, the TFT array substrate of the present invention further comprises an active layer 700 over the substrate 100 and a gate insulating layer 800 covering the active layer 700; the first metal layer 200 is disposed on the gate insulating layer 800.

The TFT array substrate further comprises a planarization layer 900 covering the third metal layer 600, a common electrode layer 1000 disposed on the planarization layer 900, a passivation layer 1100 covering the common electrode layer 1000, and a pixel electrode layer 1200 disposed on the passivation layer 1100.

The active layer 700 comprises a plurality of semiconductor patterns 710 located in an effective active area 110.

The first metal layer 200 further comprises a plurality of gates 230 located in the effective active area 110 and correspondingly located above the plurality of semiconductor patterns 710.

The third metal layer 600 further comprises a plurality of sources 630 and a plurality of drains 640 respectively located in the effective active area 110 and corresponding to the plurality of gates 230, and a plurality of connection electrodes 650 located in the effective active area 110.

The gate insulating layer 800, the first interlayer insulating layer 300 and the second interlayer insulating layer 500 are disposed with a plurality of sixth vias 560 located at two ends of the plurality of semiconductor patterns 710; the source 630 and the drain 640 corresponding to a semiconductor pattern 710 respectively is connected to both ends of the semiconductor pattern 710 through a sixth via 560 above the two ends of the semiconductor pattern 710.

The second interlayer insulating layer 500 is disposed with a plurality of seventh vias 570 located above the plurality of touch lines 410, and each of the connection electrodes 650 is connected to a touch line 410 via the seventh via 570.

The planarization layer 900 is disposed with a plurality of eighth vias 910 located above the plurality of connection electrodes 650; the common electrode layer 1000 comprises a plurality of common electrodes 1010 spaced apart, and each common electrode 1010 is connected to a connection electrode 650 through the eighth via 910.

The planarization layer 900 and the passivation layer 1100 are disposed with a plurality of ninth vias 920 located above the plurality of drains 640; the pixel electrode layer 1200 comprises a plurality of pixel electrodes 1210 spaced apart, and each of the pixel electrodes 1210 is connected to a drain 640 through the ninth via 920.

Specifically, the first interlayer insulating layer 300 is made of silicon nitride (SiNx); the second interlayer insulating layer 500 is made of silicon oxide (SiOx).

Specifically, the gate insulating layer 800 is made of silicon oxide.

Specifically, the common electrode layer 1000 is made of indium tin oxide (ITO).

Specifically, the element electrode layer 1200 is made of ITO.

Specifically, the second metal layer 400 is made of titanium (Ti) or molybdenum (Mo).

Moreover, referring to FIG. 6, the TFT array substrate further comprises a light-shielding layer 1300 disposed on the substrate 10 and an underlying insulating layer 1400 covering the light-shielding layer 1300; the active layer 700 is disposed on the underlying insulating layer 1400. The underlying insulating layer 1400 is formed by stacking a layer of silicon nitride and a layer of silicon oxide.

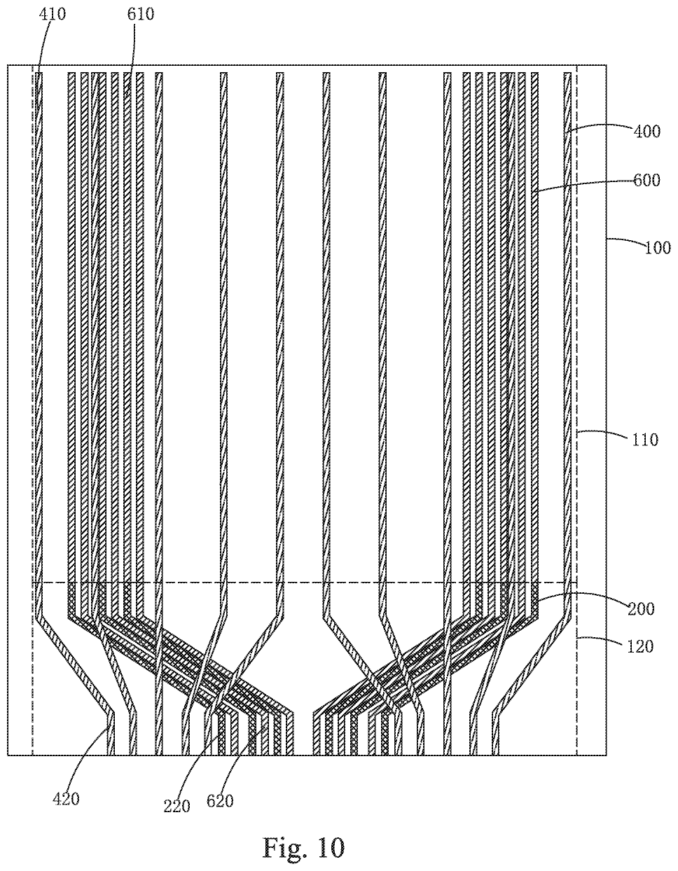

Refer to FIG. 10, FIG. 6 and FIG. 7. The TFT array substrate of the second embodiment of the present invention differs from the first embodiment is that: the plurality of first fanout lines 220 and the plurality of third fanout lines 620 are respectively electrically connected to the plurality of data lines 610, and the plurality of second fanout lines 420 are respectively electrically connected to the plurality of touch lines 410.

Specifically, referring to FIG. 10 and FIG. 7, each of the first fanout lines 220 corresponds to a data line 610, and the first interlayer insulating layer 300 and the second interlayer insulating layer 500 are disposed with a plurality of first vias 510 located above the plurality of first fanout lines 220, and the first fanout line 220 is connected to the corresponding data line 410 through the first via 510.

Referring to FIG. 10, each of the third fanout lines 620 is connected to a data line 610 correspondingly.

Referring to FIG. 10, each of the second fanout lines 420 is connected to a touch line 410 correspondingly.

Moreover, in the second embodiment of the present invention, the plurality of first fanout lines 220 and the plurality of third fanout lines 620 are used for receiving data signals, and the plurality of second fanout lines 420 are used for receiving touch signals.

The remaining of the second embodiment is the same as the first embodiment, and the detailed description will not be repeated herein.

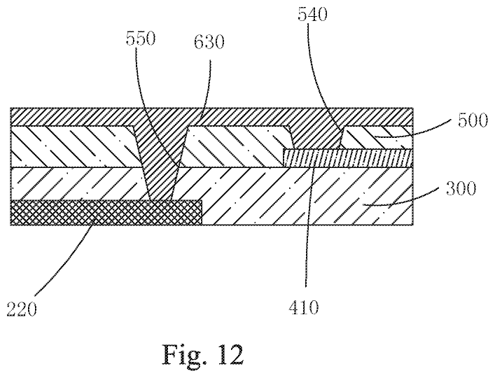

Refer to FIG. 111, FIG. 12, FIG. 6 and FIG. 8. The TFT array substrate of the third embodiment of the present invention differs from the first embodiment is that: the plurality of second fanout lines 420 and the plurality of third fanout lines 620 are electrically connected to the plurality of data lines 610, and the plurality of first fanout lines 220 are electrically connected to the plurality of touch lines 410.

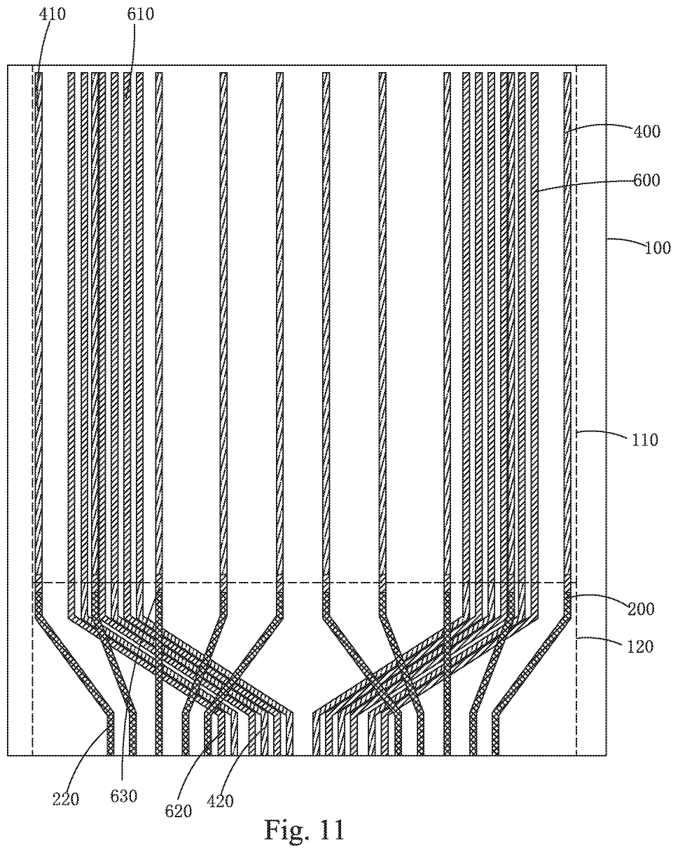

Specifically, referring to FIG. 11 and FIG. 8, each of the second fanout lines 420 corresponds to a data line 610, and the second interlayer insulating layer 500 is disposed with a plurality of second vias 520 located above the plurality of second fanout lines 420, and the second fanout line 420 is connected to the corresponding data line 610 through the second via 520.

Referring to FIG. 11, each of the third fanout lines 620 is connected to a data line 610 correspondingly.

Referring to FIG. 11 and FIG. 12, each of the first fanout lines 220 corresponds to a touch line 410, and the second interlayer insulating layer 500 is disposed with a plurality of fourth vias 540 above the plurality of touch lines 410, the first interlayer insulating layer 300 and the second interlayer insulating layer 500 are disposed with a plurality of fifth vias 550 located above the plurality of first fanout lines 220; the third metal layer 600 further comprises a plurality of connection lines 630 respectively corresponding to the plurality of touch line 410; the connection line 630 connects the corresponding touch line 410 to the first fanout line 220 through the fourth via 540 and the fifth via 550.

Moreover, in the second embodiment of the present invention, the plurality of second fanout lines 420 and the plurality of third fanout lines 620 are used for receiving data signals, and the plurality of first fanout lines 220 are used for receiving touch signals.

The remaining of the third embodiment is the same as the first embodiment, and the detailed description will not be repeated herein.

It should be noted that the TFT array substrate of the present invention disposes a plurality of first fanout lines 220 in the first metal layer 200 located in the fanout line area 120, a plurality of second fanout lines 420 in the second metal layer 400 located in the fanout line area 120, and a plurality of third fanout lines 620 in the third metal layer 600 located in the fanout line area 120; also two of the first fanout line 220, second fanout line 420 and third fanout line 620 are connected to the data lines 610, and the other is connected to the touch line 410. Because the first interlayer insulating layer 300 is disposed between the first fanout line 220 and the second fanout line 420, and the second interlayer insulating layer 500 is disposed between the third fanout line 620 and the second fanout line 420, the first fanout line 220, the second fanout line 420, and the third fanout line 620 can overlap. That is, the fanout lines connected to the data line 610 can be located in different metal layers, while the fanout lines connected to the data line is disposed in the same metal layer as in the prior art. As such, the present invention which can effectively reduce the fanout line area and help to achieve a narrow border. Furthermore, in the present invention, the second metal layer 400 where the second fanout line 420 and the touch line 410 are located is disposed between the first metal layer 200 and the third metal layer 600 where the data line 610 is located. Compared to the prior art, the metal layer where the touch line is located is disposed above the metal layer where the data line is located, and the top layer interlayer insulating layer is disposed above the touch line and patterned. The present invention can reduce the number of masks by one for fabrication. The process can simplify the production process and reduce costs.

Based on the same concept, the present invention also provides a liquid crystal display panel comprising the above TFT array substrate.

It should be noted that the TFT array substrate of the LCD panel of the present invention disposes a plurality of first fanout lines 220 in the first metal layer 200 located in the fanout line area 120, a plurality of second fanout lines 420 in the second metal layer 400 located in the fanout line area 120, and a plurality of third fanout lines 620 in the third metal layer 600 located in the fanout line area 120; also two of the first fanout line 220, second fanout line 420 and third fanout line 620 are connected to the data lines 610, and the other is connected to the touch line 410. Because the first interlayer insulating layer 300 is disposed between the first fanout line 220 and the second fanout line 420, and the second interlayer insulating layer 500 is disposed between the third fanout line 620 and the second fanout line 420, the first fanout line 220, the second fanout line 420, and the third fanout line 620 can overlap. That is, the fanout lines connected to the data line 610 can be located in different metal layers, while the fanout lines connected to the data line is disposed in the same metal layer as in the prior art. As such, the present invention which can effectively reduce the fanout line area and help to achieve a narrow border. Furthermore, in the present invention, the second metal layer 400 where the second fanout line 420 and the touch line 410 are located is disposed between the first metal layer 200 and the third metal layer 600 where the data line 610 is located. Compared to the prior art, the metal layer where the touch line is located is disposed above the metal layer where the data line is located, and the top layer interlayer insulating layer is disposed above the touch line and patterned. The present invention can reduce the number of masks by one for fabrication. The process can simplify the production process and reduce costs.

In summary, the TFT array substrate provided by the present invention comprises a first metal layer, a first interlayer insulating layer, a second metal layer, a second interlayer insulating layer and a third metal layer which are sequentially disposed above the substrate, and the first metal layer comprises a plurality of first fanout lines in the fanout line area, the second metal layer comprises a plurality of second fanout lines located in the fanout line area, and the third metal layer comprises a plurality of third lines located in the fanout line area; two of the first fanout line, the second fanout line, and the third fanout line are connected to the data lines, and the other is connected with the touch line; because the first interlayer insulating layer is disposed between the first fanout line and the second fanout line, and the second interlayer insulating layer is disposed between the third fanout line and the second fanout line, the first fanout line, the second fanout line, and the third fanout line can overlap, which can effectively reduce the fanout line area and help to achieve a narrow border. The fanout line area of an LCD panel provided by the invention has a small size, which is advantageous for realizing a narrow border.

It should be noted that in the present disclosure the terms, such as, first, second are only for distinguishing an entity or operation from another entity or operation, and does not imply any specific relation or order between the entities or operations. Also, the terms “comprises”, “include”, and other similar variations, do not exclude the inclusion of other non-listed elements. Without further restrictions, the expression “comprises a . . . ” does not exclude other identical elements from presence besides the listed elements.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A thin film transistor (TFT) array substrate, comprising: a substrate, a first metal layer disposed over the substrate, a first interlayer insulating layer covering the first metal layer, a second metal layer disposed on the first interlayer insulating layer, a second interlayer insulating layer covering the second metal layer, and a third metal layer disposed on the second interlayer insulating layer;
the substrate comprising an effective active area and a fanout line area disposed in sequence; the first metal layer comprising a plurality of first fanout lines located in the fanout line area; and the second metal layer comprising a plurality of touch lines located in the effective active area and a plurality of second fanout lines located in the fanout line area; the third metal layer comprising a plurality of data lines located in the effective active area and a plurality of third fanout lines located in the fanout line area;
the plurality of first fanout lines and the plurality of second fanout lines being respectively electrically connected to the plurality of data lines, and the plurality of third fanout lines being respectively electrically connected to the plurality of touch lines; or
the plurality of first fanout lines and the plurality of third fanout lines being respectively electrically connected to the plurality of data lines, and the plurality of second fanout lines being respectively electrically connected to the plurality of touch lines; or
the plurality of second fanout lines and the plurality of third fanout lines being electrically connected to the plurality of data lines, and the plurality of first fanout lines being electrically connected to the plurality of touch lines.

2. The TFT array substrate as claimed in claim 1, wherein the plurality of first fanout lines and the plurality of second fanout lines are respectively electrically connected to the plurality of data lines, and the plurality of third fanout lines are respectively electrically connected to the plurality of touch lines;
each of the first fanout lines corresponds to a data line, and the first interlayer insulating layer and the second interlayer insulating layer are disposed with a plurality of first vias located above the plurality of first fanout lines, and the first fanout line is connected to the corresponding data line through the first via;
each of the second fanout lines corresponds to a data line, and the second interlayer insulating layer is disposed with a plurality of second vias located above the plurality of second fanout lines, and the second fanout line is connected to the corresponding data line through the second via;
each of the third fanout lines corresponds to a touch line, and the second interlayer insulating layer is provided with a plurality of third vias located above the plurality of touch lines, and the third fanout line is connected to the corresponding touch line through the third via.

3. The TFT array substrate as claimed in claim 2, wherein the plurality of first fanout lines and the plurality of second fanout lines are used for receiving data signals, and the plurality of third fanout lines are used for receiving touch signals.

4. The TFT array substrate as claimed in claim 1, wherein the plurality of first fanout lines and the plurality of third fanout lines are respectively electrically connected to the plurality of data lines, and the plurality of second fanout lines are respectively electrically connected to the plurality of touch lines;
each of the first fanout lines corresponds to a data line, and the first interlayer insulating layer and the second interlayer insulating layer are disposed with a plurality of first vias located above the plurality of first fanout lines, and the first fanout line is connected to the corresponding data line through the first via;
each of the third fanout lines is connected to a data line correspondingly;
each of the second fanout lines is connected to a touch line correspondingly.

5. The TFT array substrate as claimed in claim 4, wherein the plurality of first fanout lines and the plurality of third fanout lines are used for receiving data signals, and the plurality of second fanout lines are used for receiving touch signals.

6. The TFT array substrate as claimed in claim 1, wherein the plurality of second fanout lines and the plurality of third fanout lines are electrically connected to the plurality of data lines, and the plurality of first fanout lines are electrically connected to the plurality of touch lines;
each of the second fanout lines corresponds to a data line, and the second interlayer insulating layer is disposed with a plurality of second vias located above the plurality of second fanout lines, and the second fanout line is connected to the corresponding data line through the second via;
each of the third fanout lines is connected to a data line correspondingly;
each of the first fanout lines corresponds to a touch line, and the second interlayer insulating layer is disposed with a plurality of fourth vias above the plurality of touch lines, the first interlayer insulating layer and the second interlayer insulating layer are disposed with a plurality of fifth vias located above the plurality of first fanout lines; the third metal layer further comprises a plurality of connection lines respectively corresponding to the plurality of touch line; the connection line connects the corresponding touch line to the first fanout line through the fourth via and the fifth via.

7. The TFT array substrate as claimed in claim 6, wherein the plurality of second fanout lines and the plurality of third fanout lines are used for receiving data signals, and the plurality of first fanout lines are used for receiving touch signals.

8. The TFT array substrate as claimed in claim 1, wherein the TFT array substrate further comprises an active layer over the substrate and a gate insulating layer covering the active layer; the first metal layer is disposed on the gate insulating layer;
the TFT array substrate further comprises a planarization layer covering the third metal layer, a common electrode layer disposed on the planarization layer, a passivation layer covering the common electrode layer, and a pixel electrode layer disposed on the passivation layer;
the active layer comprises a plurality of semiconductor patterns located in an effective active area;
the first metal layer further comprises a plurality of gates located in the effective active area and correspondingly located above the plurality of semiconductor patterns;
the third metal layer further comprises a plurality of sources and a plurality of drains respectively located in the effective active area and corresponding to the plurality of gates, and a plurality of connection electrodes located in the effective active area;
the gate insulating layer, the first interlayer insulating layer and the second interlayer insulating layer are disposed with a plurality of sixth vias located at two ends of the plurality of semiconductor patterns; the source and the drain corresponding to a semiconductor pattern respectively is connected to both ends of the semiconductor pattern through a sixth via above the two ends of the semiconductor pattern;
the second interlayer insulating layer is disposed with a plurality of seventh vias located above the plurality of touch lines, and each of the connection electrodes is connected to a touch line via the seventh via;
the planarization layer is disposed with a plurality of eighth vias located above the plurality of connection electrodes; the common electrode layer comprises a plurality of common electrodes spaced apart, and each common electrode is connected to a connection electrode through the eighth via;
the planarization layer and the passivation layer are disposed with a plurality of ninth vias located above the plurality of drains; the pixel electrode layer comprises a plurality of pixel electrodes spaced apart, and each of the pixel electrodes is connected to a drain through the ninth via;
the first interlayer insulating layer is made of silicon nitride;
the second interlayer insulating layer is made of silicon oxide;
the gate insulating layer is made of silicon oxide;
the common electrode layer is made of indium tin oxide (ITO);
the element electrode layer is made of ITO;
the second metal layer is made of titanium or molybdenum.

9. The TFT array substrate as claimed in claim 8, wherein the TFT array substrate further comprises a light-shielding layer disposed on the substrate and an underlying insulating layer covering the light-shielding layer; the active layer is disposed on the underlying insulating layer.

10. A liquid crystal display (LCD) panel, comprising the TFT array substrate as claimed in claim 1.
